(19) United States
(12) Patent Application Publication
(10) Pub. No.: US 2003/0133594 A1
(43) Pub. Date: Jul. 17, 2003

(54) Apparatus for method of recording a location of an object having an externally viewable identifier

(76) Inventor: Alan K. Sefton, Knoxville, TN (US)

Correspondence Address: LUEDEKA, NEELY & GRAHAM, P.C., P O BOX 1871, KNOXVILLE, TN, 37901, US

(21) Appl. No.: 10/044,727

(22) Filed: Jan. 11, 2002

(51) Int. Cl. G06K 9/00

(52) U.S. Cl. 382/103

(57) ABSTRACT

An apparatus for a method of recording a location of an object having an externally viewable identifier includes a camera for capturing an image of the object identifier and a computer connected to the camera for receiving and processing the object image to identify characters of the object identifier. A locator provides an indication of the location of the object. Means are provided for outputting information, including the characters of the object identifier and the indication of the object location. The outputted information can be stored in a computer database for subsequent determination of the location of the object. The apparatus can be mounted on a vehicle for enhanced mobility.

### FIELD OF THE INVENTION

The present invention relates to apparatus for a method of recording a location of an object having an externally viewable identifier.

### BACKGROUND OF THE INVENTION

At present it is a common practice for operators of multi-storey car parks (eg at airports) to take an overnight inventory of parked cars remaining in the car parks. This is necessary to 1. help customers locate lost vehicles 2. establish a charging period in case of lost parking tickets and 3. for security issues. It is customary for an individual to walk around the car park recording number plates and vehicle locations using a pen and paper or a mobile data terminal and then input the recorded information on to a main computer base. This can lead to data entry error.

### SUMMARY OF THE INVENTION

The present invention provides apparatus for recording a location of an object having an object identifier, the apparatus comprising:

camera means for capturing an image of the object identifier;

computer processing means connected to the camera means which receives the captured image of the object identifier and processes the image to identify characters of the object identifier;

locator means for providing an indication of the location of the object; and

output means for outputting information comprising the characters of the object identifier as identified by the computer processing means together with the indication of the location of the object as provided by the locator means; wherein

the apparatus is mountable on a vehicle and thereby transportable about a vicinity in which is situated an object to be located; the camera means can capture the image of the visible object identifier on the object once located; the locator means gives an indication of the position of the object once located; and the output means outputs information regarding the object identifier and the position of the object, such information being storable in a computer database whereby the location of the object can be subsequently determined by input into the database of the characters of the object identifier on the object.

### BRIEF DESCRIPTION OF THE DRAWINGS

A preferred embodiment of the present invention will now be described with reference to the accompanying drawings in which:

FIG. 1 is a view of one floor of a multi-storey car park with a parked vehicle and a vehicle having location recording apparatus according to the present invention;

FIG. 2 is a schematic representation of a multi-storey car park with vehicles parked overnight;

FIG. 3 is a schematic representation illustrating the components of location recording apparatus according to the present invention; and

FIG. 4 is a flow diagram illustrating the method of the present invention.

### DETAILED DESCRIPTION OF THE PREFFERED EMBODIMENT(S)

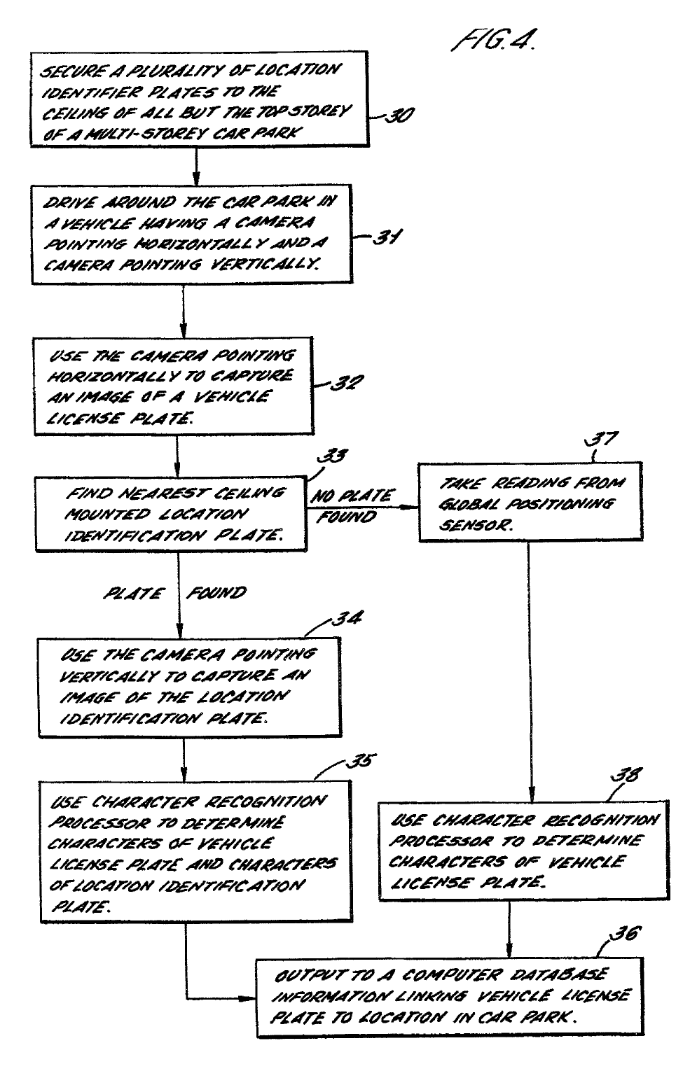

Turning first to FIG. 3, there can be seen in the figure a preferred embodiment of location recording apparatus comprising: a first camera 10, a second camera 11, a third camera 12, a global positioning sensor 13, a wireless LAN modem 14, a central processor 15 and an electrical connector 16.

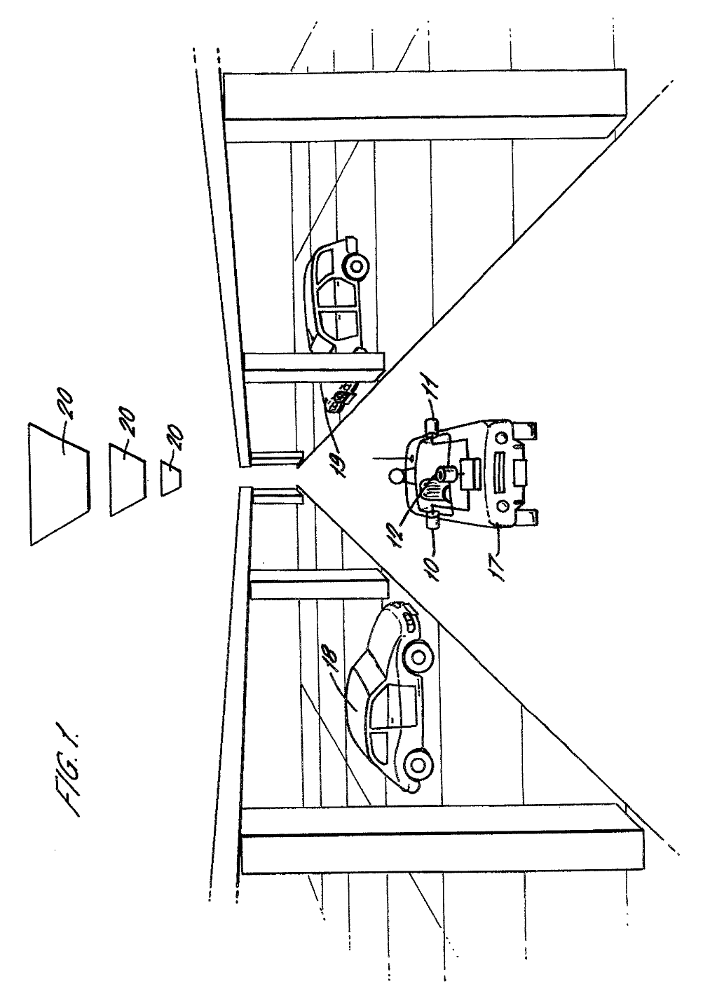

In FIG. 1 the location recording apparatus can be seen mounted on a vehicle 17. The first camera 10 captures images on the left of the vehicle, the second camera 11 captures images of the right of the vehicle 17 and the third camera 12 captures images above the vehicle 17. Each of the cameras 10, 11, 12 is a “shuttered and gated” camera such as a P3567 camera supplied by the PIPS Technology, Inc. in that the cameras record images with reduced image blur. Preferably each camera is an infrared camera having an integral infrared illuminator.

In a first step 30 of a method according to the invention (as illustrated by the flow diagram of FIG. 4) location identifier plates 20 are secured to the ceilings of cell floors of a multi-storey car park except the top floor (which has no ceiling). Next, at step 31,the vehicle 17 is driven around the multi-storey car park on a predetermined route. Then, at step 32, the cameras 10 and 11 will record images of licence/number plates of parked vehicles eg. 18, 19 respectively to the left and right of the vehicle 17 as the vehicle 17 drives past. At the same time (as shown at steps 33 and 34) the camera 12, which points vertically upwards, records images of location identifier plates 20 fixed to the ceiling of the multi-storey car park. The plates 20 preferably have infra-red readable barcodes as described in U.S. patent application Ser. No. 09/817,752, but could equally well have other viewable characters such as alphanumeric characters.

The images recorded by the cameras 10, 11 and 12 are all relayed (at step 35) to the central processor unit 15, eg a P357 number plate processor unit supplied by PIPS Technology, Inc. The processor unit 15 is programmed to recognise the characters of on the photographed licence/number plates and the ceiling mounted identification plates. Then, at step 36, the processor unit 15 relays (via the wireless LAN modem 14) to a database system 26 the information comprising the characters of the recorded licence/number plates and associated location data captured from the recorded images of the ceiling plates. Alternatively, the information may be stored locally in the P3567 number plate processor and transferred to the database system 26 via a directly wired computer network (externet) connection.

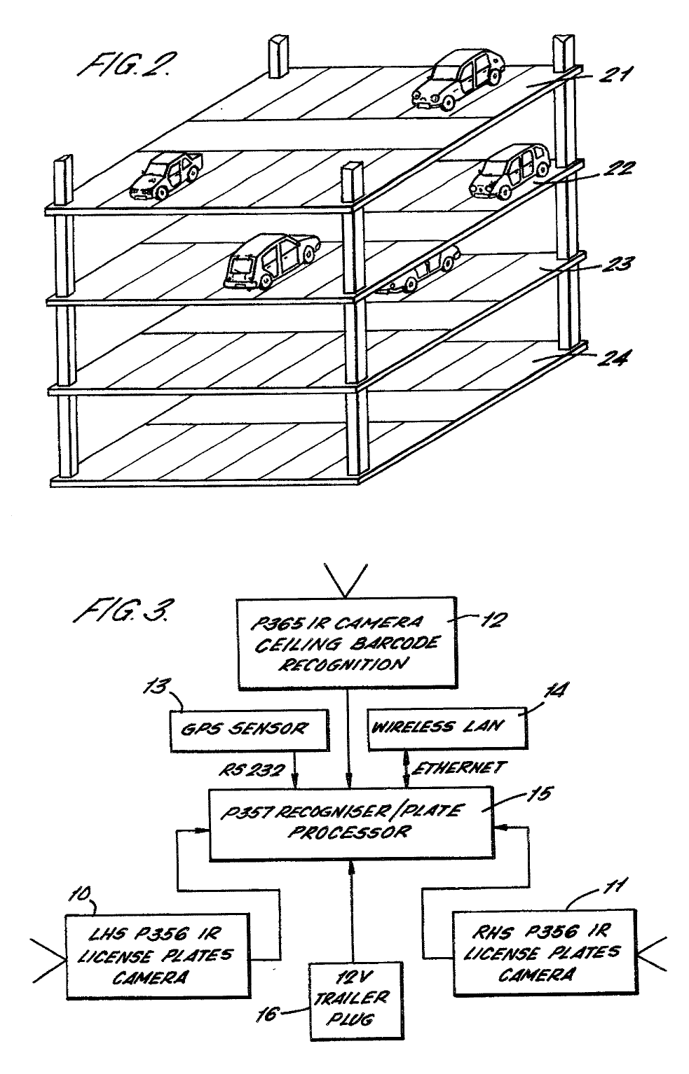

The information once stored in the computer database system can be retrieved easily so that vehicle owners can locate their lost vehicles by inputting the characters of their vehicles' licence/number plates into the computer database. The information on the location identifier plates 20 will specify what floor (21, 22, 23, 24—see FIG. 2) of the multi-storey car park the vehicle is located and which parking bay. The collected information will be stored along with time and date information so that the database records for each vehicle at least a first day on which the vehicle was in the car park so that correct charges can be made in cases of lost tickets.

To cope with the top floors of multi-storey car parks with no ceilings. An absence of an image scanned by the camera could be taken (at stop 33) to indicate the top floor location and in this case location information supplied by the global positioning sensor 13 (at step 37) could be linked in association with the licence/number plate characters determined from the captured image at step 38 and then output step 36 to a database so that the position of the vehicle on the top floor can be recorded. Alternatively, the apparatus could have a camera pointing vertically downwards instead of upwards, to read characters on location identification plates secured on the floor of the car park.

The invention is also applicable to flat, open, large area car parks. For such car parks the camera 12 can be dispensed with and the information provided by the global positioning sensor 13 will be sufficient to identify a vehicle's location.

Shown in FIG. 3 is an electrical connector 16 which enables the apparatus to be connected to the 12 volt power supply of the vehicle 17. However, the apparatus could equally well be provided with its own battery supply.

In a variation on the method described above, the location data could be displayed on plates mounted on columns in the car park or on display signs, both readable by the cameras 10, 11 pointing left and right of the vehicle, without the need for a vertically pointing camera 12.

While above the invention has been described with reference to the position of automobiles in a car park, the invention is equally applicable in other situations, eg to record the location of stock in a warehouse (the stock would need to display externally viewable identifiers, eg barcodes, which could be recorded). The identifiers could be visible to the human eye or viewable only e.g. under special illumination such as infra-red illumination.

The vehicle 17 could be a robot vehicle either moving according to programmed instructions or operated by remote control.

What is claimed is:

1. Apparatus for recording a location of an object having an object identifier, the apparatus comprising:
camera means for capturing an image of the object identifier;
computer processing means connected to the camera means which receives the captured image of the object identifier and processes the image to identify characters of the object identifier;
locator means for providing an indication of the location of the object; and
output means for outputting information comprising the characters of the object identifier as identified by the computer processing means together with the indication of the location of the object as provided by the locator means; wherein
the apparatus is mountable on a vehicle and thereby transportable about a vicinity in which is situated an object to be located; the camera means can capture the image of the visible object identifier on the object once located; the locator means gives an indication of the position of the object once located; and the output means outputs information regarding the object identifier and the position of the object, such information being storable in a computer database whereby the location of the object can be subsequently determined by input into the database of the characters of the object identifier on the object.

2. Apparatus as claimed in claim 1 wherein:
the locator means comprises a global positioning sensor.

3. Apparatus as claimed in claim 1 wherein:
the locator means is provided by the camera means and the computer processing means, the camera means capturing an image of a visible location identifier secured in place in proximity to the object and the computer processing means receiving the captured image of the location identifier and processing the image to identify the characters of the location identifier; and
the output means output;
the characters of the location identifier linked to the characters of the object identifier.

4. Apparatus as claimed in claim 3 wherein:
the camera means comprises a first camera for capturing an image of the object identifier and a second camera for capturing an image of the location identifier.

5. Apparatus as claimed in claim 4 wherein the camera means additionally comprises a third camera also for capturing an image of an object identifier.

6. A vehicle having mounted thereon an apparatus as claimed in claim 5 wherein the first and third cameras capture images respectively left and right of the vehicle and the second camera captures images above the vehicle.

7. Apparatus as claimed in claim 1 wherein the output means comprises a wireless transmitter.

8. Apparatus as claimed in claim 1 comprising additionally a connector for connecting the apparatus to a external power supply.

9. Apparatus as claimed in claim 1 wherein each camera of the camera means in a infra-red camera having associated therewith an infra-red illuminator.

10. A method of recording a location of an object having an object identifier, the method comprising:
conveying around a vicinity in which the object is situated an apparatus having camera means, computer processing means, location means and output means;
using the camera means of the apparatus to capture an image of the object identifier;
using the computer processing means of the apparatus to process the captured image to identify characters of the object identifier;
using the locator means of the apparatus to provide an indication of the location of the object; and
outputting from the apparatus to be stored in a computer database information comprising the characters of the object identifier as determined by the computer processing means of the apparatus linked with the location indication provided by the locator means.

11. A method as claimed in claim 10 wherein:
a global positioning sensor is used as the locator means.

12. A method as claimed in claim 10 comprising additionally the steps of:
securing in place in the vicinity of the object a plurality of location identifiers prior to location of the object;
using the camera means to capture an image of at lest one of the location identifiers closest to the object once located; and
using the computer processing means to process the captured image of the at least one of the location identifiers to identify characters therein; whereby:
the camera means and the computer processing means are used together as the locator means so that the information output to be stored in the computer database comprises the identified characters of the object identifier linked with the identified characters of the location identifier closest to the object.

13. A method as claimed in claim 10 wherein the object located in the method is a parked vehicle, the vicinity in which the vehicle is situated is a car park and the object identified is a licence plate or number plate on the vehicle.

14. A method as claimed in claim 13 comprising additionally the step of using the computer database to locate a parked vehicle by inputting characters of licence plate or number plate of the vehicle into the computer database in order to recall the location information linked to the characters of the licence plate or number plate.

15. A vehicle mounted apparatus for determining location information related to a location of one or more objects bearing an object identifier having one or more object identifying characters, the one or more objects disposed adjacent a location identifier having one or more location identifying characters, the apparatus comprising:
imaging means for obtaining an image of the object identifier and for obtaining an image of the location identifier;
a processor coupled at least to the first and second imaging devices for processing the object identifier to determine the object identifying characters, and for processing the location identifier to determine the location identifying characters; and
a wireless communication device for transmitting information indicative of the object identifying characters and the location identifying characters.

16. The apparatus of claim 15 wherein the imaging means further comprise:
a first imaging device for capturing an image of the object identifier; and
a second imaging device for capturing an image of the location identifier.

17. The apparatus of claim 16 wherein the first and second imaging devices comprise infrared cameras.

18. The apparatus of claim 15 further comprising:
a geographic location determining device for determining location co-ordinates; and
the wireless communication device for transmitting information indicative of the location co-ordinates.
